(19) United States
(12) Patent Application Publication
(10) Pub. No.: US 2015/0278680 A1
(43) Pub. Date: Oct. 1, 2015

(54) TRAINING, RECOGNITION, AND GENERATION IN A SPIKING DEEP BELIEF NETWORK (DBN)

(71) Applicant: QUALCOMM Incorporated, San Diego, CA (US)

(72) Inventors: Venkata Sreekanta Reddy ANNAPUREDDY, San Diego, CA (US); David Jonathan JULIAN, San Diego, CA (US); Anthony SARAH, San Diego, CA (US)

(21) Appl. No.: 14/659,516

(22) Filed: Mar. 16, 2015

Related U.S. Application Data
(60) Provisional application No. 61/970,807, filed on Mar. 26, 2014.

(51) Int. Cl. G06N 3/04; G06N 3/08

(52) U.S. Cl. CPC G06N 3/04; G06N 3/08

(57) ABSTRACT

A method of distributed computation includes computing a first set of results in a first computational chain with a first population of processing nodes and passing the first set of results to a second population of processing nodes. The method also includes entering a first rest state with the first population of processing nodes after passing the first set of results and computing a second set of results in the first computational chain with the second population of processing nodes based on the first set of results. The method further includes passing the second set of results to the first population of processing nodes, entering a second rest state with the second population of processing nodes after passing the second set of results and orchestrating the first computational chain.

### CROSS-REFERENCE TO RELATED APPLICATION

The present application claims the benefit of U.S. Provisional Patent Application No. 61/970,807, filed on Mar. 26, 2014, and titled “TRAINING, RECOGNITION, AND GENERATION IN A SPIKING DEEP BELIEF NETWORK (DBN),” the disclosure of which is expressly incorporated by reference herein in its entirety.

### BACKGROUND

1. Field

Certain aspects of the present disclosure generally relate to computational nodes and, more particularly, to systems and methods for distributed computation.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

### SUMMARY

In an aspect of the present disclosure, a method of distributed computation is presented. The method includes computing a first set of results in a first computational chain with a first population of processing nodes and passing the first set of results to a second population of processing nodes. The method also includes entering a first rest state with the first population of processing nodes after passing the first set of results and computing a second set of results in the first computational chain with the second population of processing nodes based on the first set of results. The method further includes passing the second set of results to the first population of processing nodes, entering a second rest state with the second population of processing nodes after passing the second set of results and orchestrating the first computational chain.

In another aspect of the present disclosure, an apparatus for distributed computation is presented. The apparatus includes a memory and at least one processor coupled to the memory. The one or more processors are configured to compute a first set of results in a first computational chain with a first population of processing nodes and to pass the first set of results to a second population of processing nodes. The processor(s) is(are) also configured to enter a first rest state with the first population of processing nodes after passing the first set of results and to compute a second set of results in the first computational chain with the second population of processing nodes based on the first set of results. The processor(s) is(are) further configured to pass the second set of results to the first population of processing nodes, to enter a second rest state with the second population of processing nodes after passing the second set of results and to orchestrate the first computational chain.

In yet another aspect of the present disclosure, an apparatus for distributed computation is presented. The apparatus includes means for computing a first set of results in a first computational chain with a first population of processing nodes and means for passing the first set of results to a second population of processing nodes. The apparatus also includes means for entering a first rest state with the first population of processing nodes after passing the first set of results and means for computing a second set of results in the first computational chain with the second population of processing nodes based on the first set of results. The apparatus further includes means for passing the second set of results to the first population of processing nodes, means for entering a second rest state with the second population of processing nodes after passing the second set of results and means for orchestrating the first computational chain.

In still another aspect of the present disclosure, a computer program product for distributed computation is presented. The computer program product includes a non-transitory computer readable medium having encoded thereon program code. The program code includes program code to compute a first set of results in a first computational chain with a first population of processing nodes and to pass the first set of results to a second population of processing nodes. The program code also includes program code to enter a first rest state with the first population of processing nodes after passing the first set of results and to compute a second set of results in the first computational chain with the second population of processing nodes based on the first set of results. The program code further includes program code to pass the second set of results to the first population of processing nodes, to enter a second rest state with the second population of processing nodes after passing the second set of results and to orchestrate the first computational chain.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9 is a block diagram illustrating an exemplary RBM in accordance with aspects of the present disclosure.

FIG. 10 is a block diagram illustrating an exemplary DBN in accordance with aspects of the present disclosure.

FIG. 11 is a block diagram illustrating parallel sampling chains in an RBM in accordance with aspects of the present disclosure.

FIG. 12, is a block diagram illustrating an RBM with orchestrator neurons in accordance with aspects of the present disclosure.

FIGS. 13A-F are block diagrams illustrating exemplary DBN trained for classification, recognition and generation in accordance with aspects of the present disclosure.

FIGS. 14-15 illustrate methods for distributed computation in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

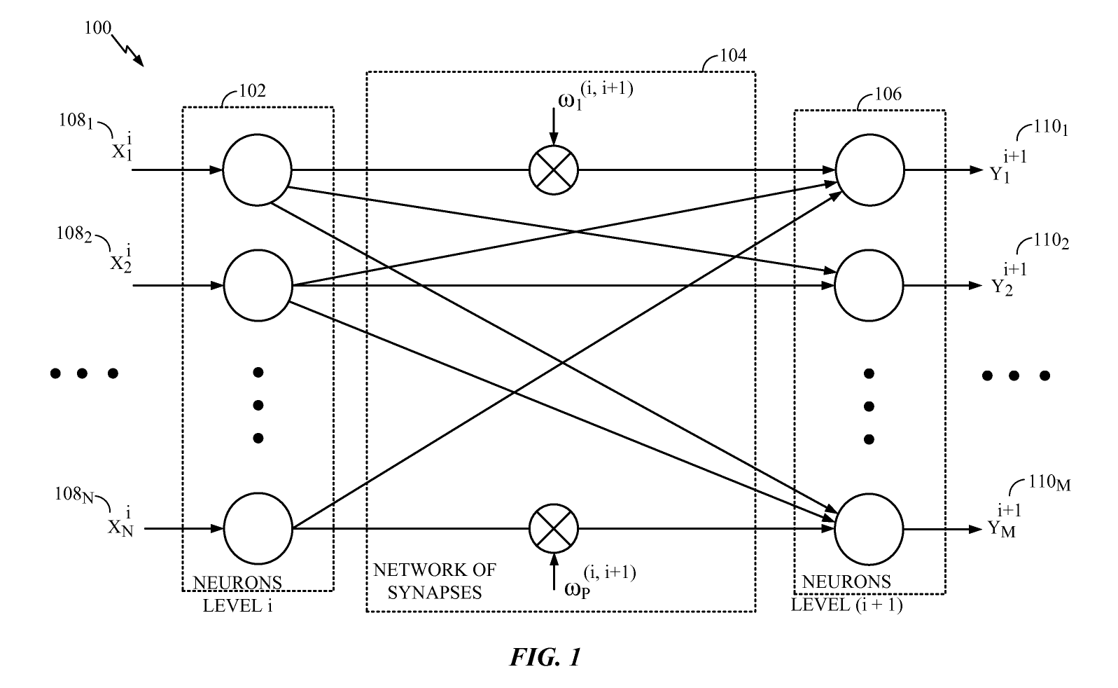

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

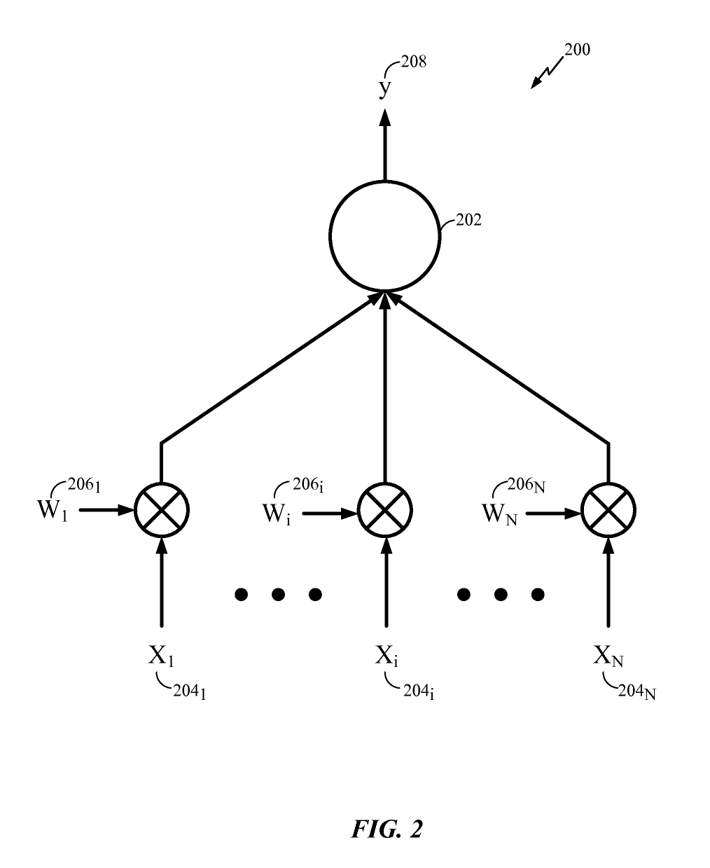

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , t > 0 \\ {a}_{-} {e}^{t / {k}_{-}} , t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

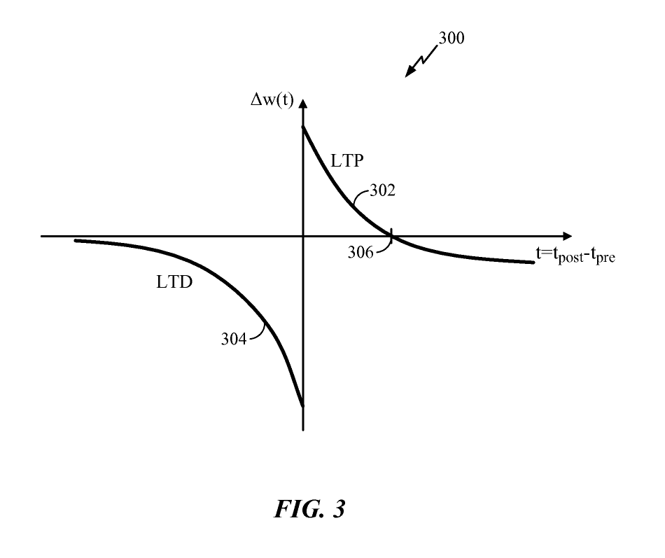

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) , & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

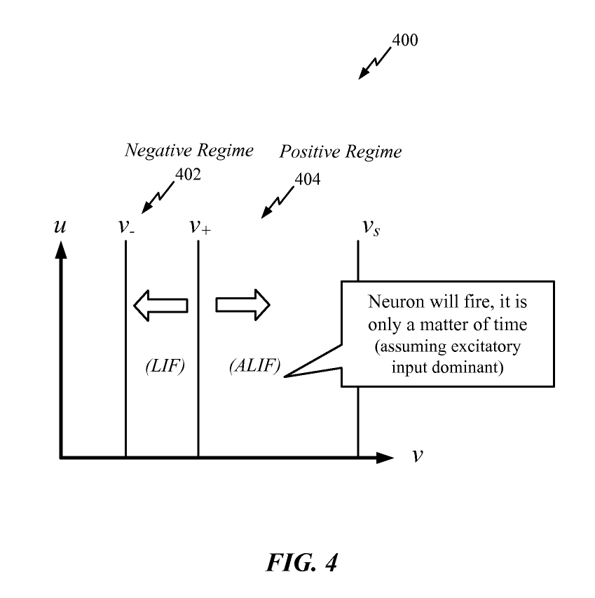

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r , & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε), (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter s is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value vₛ. Subsequently, the state may be reset at a reset event (which may be one and the same as the spike event):

v=\hat{v}₋ (9)

u=u+Δu, (10)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r . & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} . \qquad ( 13 )$$

If a spike is defined as occurring at the time the voltage state v reaches vₛ, then the closed-form solution for the amount of time, or relative delay, until a spike occurs as measured from the time that the voltage is at a given state v is:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Distributed Computation

Aspects of the present disclosure are directed to distributed computation. The computation may be distributed over a population of processing nodes, which in some aspects, may be configured in one or more computational chains. In one exemplary configuration, the distributed computation is implemented via a Deep Belief Network (DBN). In some aspects, a DBN may be obtained by stacking up layers of Restricted Boltzmann Machines (RBMs). An RBM is a type of artificial neural network that can learn a probability distribution over a set of inputs. The bottom RBMs of the DBN may serve as feature extractors and the top RBM may serve as a classifier.

In some aspects, the DBN may be constructed using a spiking neural network (SNN) and may be binary. A spiking DBN may be obtained by stacking up spiking RBMs. In one example, a DBN is obtained by stacking a spiking RBM as a feature extractor and a spiking RBM as a classifier.

A DBN may be trained via a training process such as Contrastive-Divergence (CD), for example. In some aspects, each RBM of a DBN may be trained separately.

Given a pre-trained RBM, a spiking neural network or other network may be configured to perform sampling operations. In one exemplary configuration, a SNN may perform Gibbs sampling. Further, the SNN may port the weight values of the pre-trained RBM into the SNN.

Multiple parallel sampling chains (e.g., Gibbs sampling chains) may be included in the RBM running in the spiking neural network. In some aspects, the number of parallel sampling chains may correspond to a synaptic delay associated with the chains. For example, in some configurations, the number of parallel sampling chains may be equal to the value of d_{f}+dᵣ, where d_{f} and dᵣ represent forward and reverse synaptic delays, respectively. Additionally, one or more of the sampling chain in an RBM may be selectively stopped or suppressed. For example, in some aspects, a sampling chain may be suppressed via an external input. In other aspects, a sampling chain may be suppressed by passing in band message tokens between nodes of the sampling chain.

### Spiking RBM as Feature Extractor

A trained RBM may be used as a generative model through sampling (e.g., Gibbs sampling), as a feature extractor, or as a classifier.

In one configuration, the nodes of the RBM may comprise neurons. In this configuration, when the RBM is used as feature extractor, spikes may propagate in the forward direction (i.e., from the visible layer to the hidden layer). In some aspects, the RBM may be operated such that the spikes only propagate in a forward direction. In this case, the RBM may be operated using the forward synapses. Further, in some aspects, the reverse synapses may be disabled from the hidden layer neurons to the visible layer neurons.

In order to compute a feature vector, spikes may be input into the visible layer neurons through extrinsic axons based on an input pattern (or feature) x. A spike may be input into the visible layer neuron vᵢ if xᵢ=1, for example. This creates a spike pattern x in visible layer neurons at some time t (i.e., v^{(f)}=x). Additionally, a positive current may be input to the bias neuron v₀ to make the bias neuron spike at the same time t.

These spikes may be propagated to the hidden neurons after a propagation delay of d_{f} tau resulting in a hidden state vector h^{(t+df)}, which may serve as a feature vector corresponding to the input x.

### Spiking RBM as Classifier

In some aspects, the spiking RBM may be configured as a classifier. In this configuration, x may represent the input (or feature) vector to be classified and y may represent a binary index vector representing class labels. The spiking RBM may be trained on a joint vector by appending the input vector and the label vector as v=[x; y]. Accordingly, the hidden layer neurons may learn correlations between the input vectors and the label vectors from the training set.

In some aspects, it may be desirable to estimate a label vector y for a given input vector x. An RBM classifier may accomplish this through conditional Gibbs sampling or other sampling processes, for example. In conditional Gibbs sampling, the input neuron states may be clamped to the pattern x. With the input pattern clamped to x, the spiking RBM may generate different label vector patterns according to the conditional probability distribution function P (y|x). The most frequent label vector pattern may provide the best estimate ŷ.

### Clamping Input Spike Pattern

A Gibbs sampling chain may visit and update input neurons after every d_{f}+dᵣ tau. However, for inference purposes, the input spike pattern may not be updated. Instead, in some aspects, the input spike pattern may be clamped according to a fixed pattern x. This may be accomplished by disabling the reverse synapses from the hidden layer into the input neurons and by adding recurrent synapses from the input neurons to themselves with a delay of d_{f}+dᵣ tau and an increased weight of W_{rec}. With this modification, the input spike pattern x may be input once into the Gibbs sampling chain. Accordingly, the same spike pattern will repeat after every d_{f}+dᵣ tau.

### Counting Label Neuron Spikes

As the spiking RBM performs conditional Gibbs sampling, it may be desirable to count the number of spikes from each label neuron and use the count to make a classification decision. A counter neuron may be included for each label neuron with a synapse from each label neuron to the corresponding counter neuron. In one exemplary aspect, the synapse may be configured with unit delay and/or unit weight.

The counter neurons may comprise integrate and fire neurons such as, Leaky Integrate and Fire (LIF) neurons, Stochastic Leaky Integrate and Fire (SLIF) and the like. Of course, this is merely exemplary and other types of model neurons may also be used. The spikes from the label counter neurons are the output spikes from the spiking RBM classifier. In some configurations, the counter neurons may be configured with a threshold (e.g., a ring threshold). The time taken for a classification may be set in accordance with the threshold of the counter neurons.

### Network Reset

In some configurations, the distributed computation system may be configured to perform a reset operation. For example, a spiking neural network may be reset after an output spike is dispatched from the network to avoid multiple output spikes. In another example, the network may be reset before feeding a new input vector for classification. In a further example, a network reset may implemented by suppressing all of the d_{f}+dᵣ sampling chains and resetting the membrane potential of the counter neurons.

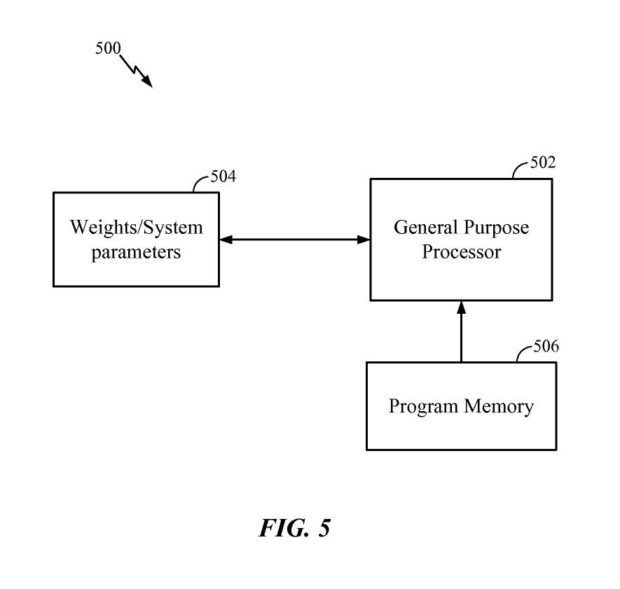

FIG. 5 illustrates an example implementation 500 of the aforementioned distributed computation using a general-purpose processor 502 in accordance with certain aspects of the present disclosure. Variables (neural signals), synaptic weights, system parameters associated with a computational network (neural network), delays, and frequency bin information may be stored in a memory block 504, while instructions executed at the general-purpose processor 502 may be loaded from a program memory 506. In an aspect of the present disclosure, the instructions loaded into the general-purpose processor 502 may comprise code for computing a first set of results in a first computational chain with a first population of processing nodes, passing the first set of results to a second population of processing nodes, and entering a first rest state with the first population of processing nodes after passing the first set of results. The instructions may also comprise code for computing a second set of results in a first computational chain with the second set of processing nodes based on the first set of results, passing the second set of results to the first population of processing nodes, entering a second rest state with the second population of processing nodes after passing the second set of results, and orchestrating the first computation chain.

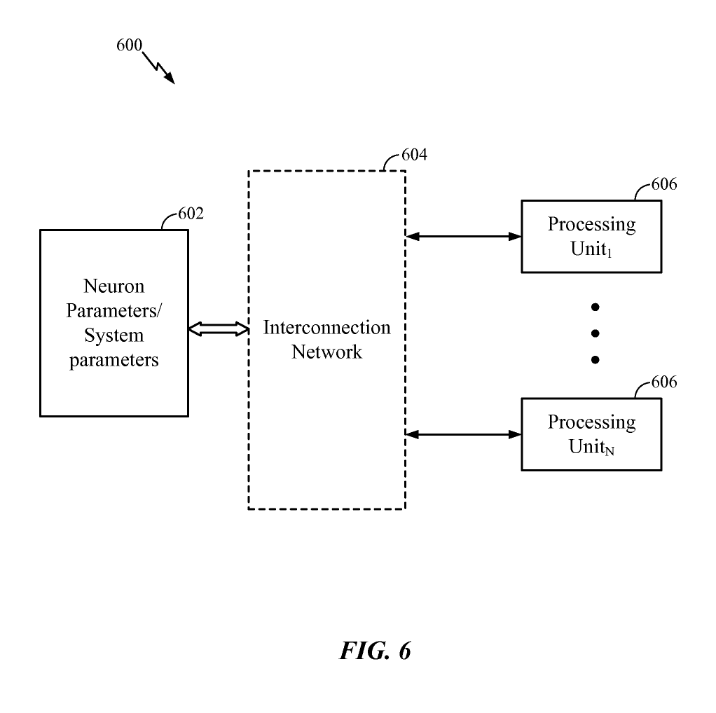

FIG. 6 illustrates an example implementation 600 of the aforementioned distributed computation where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, frequency bin information, may be stored in the memory 602, and may be loaded from the memory 602 via connection(s) of the interconnection network 604 into each processing unit (neural processor) 606. In an aspect of the present disclosure, the processing unit 606 may be configured to compute a first set of results in a first computational chain with a first population of processing nodes, to pass the first set of results to a second population of processing nodes, and to enter a first rest state with the first population of processing nodes after passing the first set of results. The processing unit 606 may also be configured to compute a second set of results in a first computational chain with the second set of processing nodes based on the first set of results, to pass the second set of results to the first population of processing nodes, to enter a second rest state with the second population of processing nodes after passing the second set of results, and to orchestrate the first computation chain.

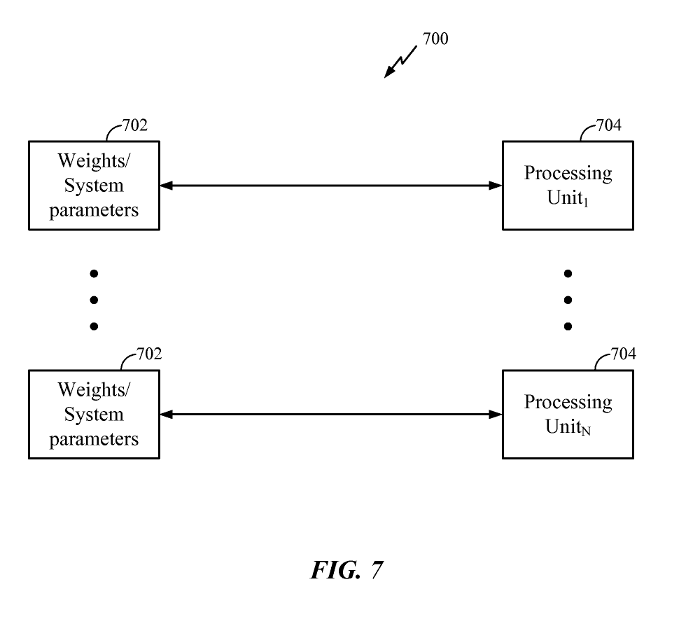

FIG. 7 illustrates an example implementation 700 of the aforementioned distributed computation. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, frequency bin information. In an aspect of the present disclosure, the processing unit 704 may be configured to compute a first set of results in a first computational chain with a first population of processing nodes, to pass the first set of results to a second population of processing nodes, and to enter a first rest state with the first population of processing nodes after passing the first set of results. The processing unit 704 may also be configured to compute a second set of results in a first computational chain with the second set of processing nodes based on the first set of results, to pass the second set of results to the first population of processing nodes, to enter a second rest state with the second population of processing nodes after passing the second set of results, and to orchestrate the first computation chain.

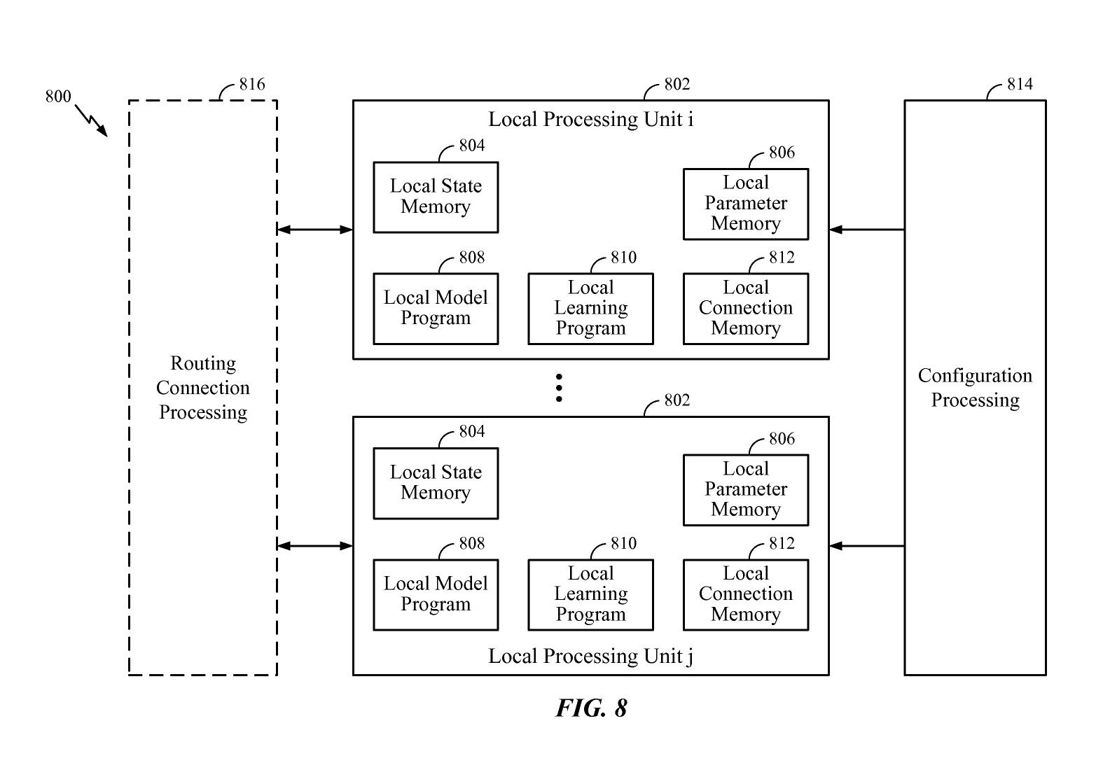

FIG. 8 illustrates an example implementation of a neural network 800 in accordance with certain aspects of the present disclosure. As illustrated in FIG. 8, the neural network 800 may have multiple local processing units 802 that may perform various operations of methods described herein. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processor unit 814 for providing configurations for local memories of the local processing unit, and with a routing connection processing unit 816 that provide routing between the local processing units 802.

In one configuration, a neuron model is configured for distributed computation. The neuron model includes means for computing a first set of results, means for passing the first set of results, means for entering a first rest state, means for computing a second set of results, means for passing the second set of results, means for entering a second rest state, and orchestrating means. In one aspect, the means for computing a first set of results, means for passing the first set of results, means for entering a first rest state, means for computing a second set of results, means for passing the second set of results, means for entering a second rest state, and/or orchestrating means may be the general-purpose processor 502, program memory 506, memory block 504, memory 602, interconnection network 604, processing units 606, processing unit 704, local processing units 802, and or the routing connection processing units 816 configured to perform the functions recited.

In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and to develop the one or more functional features towards the desired functional features as the determined parameters are further adapted, tuned and updated.

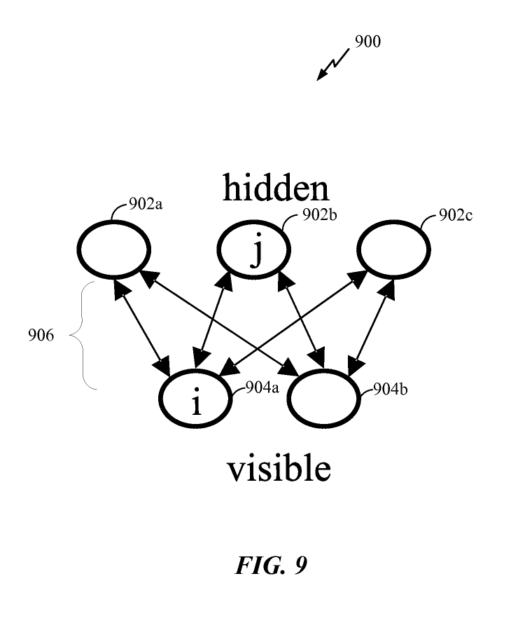

FIG. 9 is a block diagram illustrating an exemplary RBM 900 in accordance with aspects of the present disclosure. Referring to FIG. 9, the exemplary RBM 900 includes two layers of neurons typically referred to as visible (904a and 904b) and hidden (902a, 902b, and 902c). Although, two neurons are shown in the visible layer and three are shown in the hidden layer, the number of neurons in each layer is merely exemplary and for ease of illustration and explanation and not limiting.

Each of the neurons of the visible layer may be connected to each of the neurons in the hidden layer by a synaptic connection 906. However, in this exemplary RBM, no connection is provided between neurons of the same layer.

The visible and hidden neuron states may be respectively represented by vε{0,1}ⁿ and hε{0,1}^{m}. In some aspects, the RBM 900 may model a parametric joint distribution of visible and hidden vectors. For example, the RBM 900 may assign the joint state vector (v; h) a probability of:

$$P ( v , h ) = \frac{1}{Z} {e}^{- E ( v , h )} , \qquad ( 15 )$$

where Z is a normalization factor and E(v,h) is an energy function. The energy function E(v,h) may, for example, be defined as:

$$E ( v , h ) = - ( {\sum }_{i = 1}^{n} {a}_{i} {v}_{i} + {\sum }_{j = 1}^{m} {b}_{j} {h}_{j} + {\sum }_{i = 1}^{n} {\sum }_{j = 1}^{m} {w}_{ij} {v}_{i} {h}_{j} ) , \qquad ( 16 )$$

where wᵢⱼ is a weight, and aᵢ and bⱼ are parameters.

Accordingly, the probability that the RBM 900 assigns to a visible state vector (v) can be computed by summing over all possible hidden states:

$$P ( v ) = \frac{1}{Z} {\sum }_{h} {e}^{- E ( v , h )} . \qquad ( 17 )$$

### Training an RBM

In some aspects, training data can be used to choose the parameters a, b and W. For example, training data may be used to select parameters such that the RBM 900 assigns higher probabilities to the vectors (v) in the training dataset. More specifically, parameters may be selected to increase the sum of log probabilities of all training vectors:

$$max {\sum }_{v = training vectors} log P ( v ) . \qquad ( 18 )$$

In one configuration, the Contrastive-Divergence (CD) may be used to approximate the parameters of the RBM 900. Contrastive Divergence, also referred to as CD-k is a technique for approximating a solution, where ‘k’ denotes a number of “up-down” sampling events in sampling chain.

For each training vector, the CD process updates RBM weights. In one exemplary aspect, CD−1 may be used to update the RBM weights. The visible layer neurons may be stimulated with a training vector such that v⁽⁰⁾=v, where v is a training vector. Based on the v⁽⁰⁾, binary hidden state vector h⁽¹⁾ may be generated, for example, as follows:

$$P ( {h}_{j} ≡ 1 \vert v ) ≡ signs ( {b}_{j} + {\sum }_{i = 1}^{n} {w}_{ij} {v}_{i} ) . \qquad ( 19 )$$

Based on the hidden state vector h⁽¹⁾, binary visible state vector v⁽²⁾ may be reconstructed as follows:

$$P ( {v}_{i} = 1 \vert h ) = signs ( {a}_{i} + {\sum }_{j = 1}^{m} {w}_{ij} {h}_{j} ) . \qquad ( 20 )$$

Using the visible state vector v⁽²⁾, the binary hidden state vector h⁽³⁾ may be generated according to equation 19.

Accordingly, the weights in this example, may be updated as follows:

ΔWᵢⱼ=η(vᵢ⁽⁰⁾hⱼ⁽¹⁾−vᵢ⁽²⁾hⱼ⁽³⁾) (21)

Δaᵢ=η(vᵢ⁽⁰⁾−vᵢ⁽²⁾) (22)

Δbⱼ=η(hⱼ⁽¹⁾−hⱼ⁽³⁾), (23)

where η is a learning rate. In some aspects, the weights may be updated by presenting the same image twice (e.g., v⁽¹⁾=v⁽⁰⁾) and then applying STDP to learn the weight updates.

In some aspects, the RBM 900 may be configured for weight-sharing. That is, symmetric weight updates may be performed, such that both forward synapses and reverses synapses may be updated according to Equation 21.

### Using a Trained RBM

Once the RBM 900 has been trained, it may be advantageously applied in numerous ways. In one example, the trained RBM may be used as a generative model for sampling. In some aspects, the trained RBM may implement Gibbs sampling. Of course, this is merely exemplary and not limiting. In Gibbs sampling, samples are generated from a joint probability distribution by iteratively sampling conditional distributions. In this example, the trained RBM may be used to sample visible states according to the marginal distribution of Equation 17.

In one configuration, an arbitrary visible state v⁽⁰⁾ is initialized. The hidden and visible states may then be alternatively sampled (e.g., v⁽⁰⁾→h⁽¹⁾→v⁽²⁾→h⁽³⁾→v⁽⁴⁾ . . . ) from the conditional distributions of Equations 19 and 20.

Another exemplary use of the trained RBMs is for feature extraction. That is, the RBMs may serve as feature extractors configured to perform feature extraction on an input vector x. For example, the visible state vector v may be equal to x, generate the corresponding hidden state vector h, and use the hidden state vector as a feature vector.

The hidden neurons (e.g., 902a, 902b, 902c) may encode correlations between the visible neurons (e.g., 904a, 904b). In addition, the hidden state vector may have an improved classification in comparison to the original visible state vector based by virtue of the training.

In some configurations, additional RBMs may be trained on the feature vectors obtained from the first RBM (e.g., 900), and thus obtain a hierarchy of features with various levels of extraction (e.g., features, features of features, features of features of features, etc.). The RBMs may be stacked up to form a network of neurons. The stacked RBMs may be referred to as Deep Belief Network (DBN).

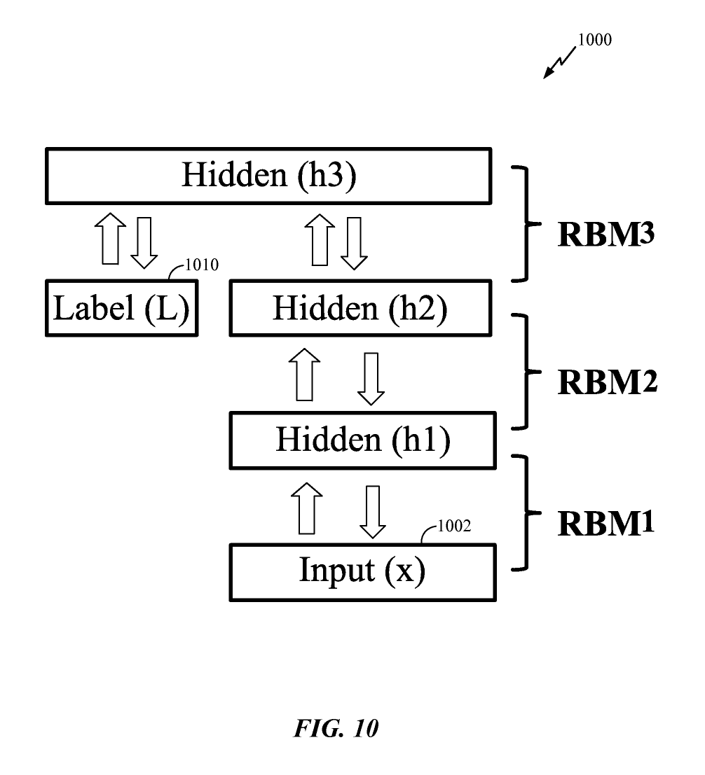

FIG. 10 is a block diagram illustrating an exemplary DBN 1000 in accordance with aspects of the present disclosure. As shown in FIG. 10, the DBN 1000 includes RBM1, RBM 2 and RBM 3. In this example, RBMs (e.g., RBM3) may be used as classifiers. Each of the RBMs may be individually trained and then stacked to form the DBN 1000. In the example of FIG. 10, an input (or feature) vector 1002 to be classified may be represented by x. On the other hand, y may represent the binary index vector representing the class labels. As such, an RBM (e.g., 900) may be used as a classifier by training it on the joint training vectors (i.e., v=[x; y]). In other words, input neurons 1002 and label neurons 1010 may be grouped and referred to as visible neurons.

Inference may be performed by fixing the input neuron 1002 states to x and performing sampling (e.g., conditional Gibbs sampling) on the remaining neuron states. As the sampling proceeds, the RBM (e.g., generates its estimate of label neuron states y conditioned on the input neuron states.

In some aspects, when layers of RBMs (e.g., RBM1, RBM2 and RBM3) are stacked up to form a DBN 1000, the bottom layers (e.g., RBM 1, RBM 2) may be used as feature extractors and the top layer (RBM 3) may be used as a classifier.

In some aspects of the present disclosure, RBMs may be generated by using spiking neurons. The spiking neuron model and the network model may be used to perform sampling (e.g., Gibbs Sampling) to generates samples of visible and hidden states in accordance with Equations (19) and (20).

In one configuration, an RBM may be obtained by having n spiking neurons represent the n-dimensional visible state vector v, and m spiking neurons represent the m-dimensional hidden state vector h. The visible neuron vᵢ may be coupled to the hidden neuron hⱼ using a forward synapse and a reverse synapse. Of course, the use of two synapses is merely exemplary and not limiting. The forward synapse propagates spikes from visible neuron to hidden neuron, and the reverse synapse propagates spikes from hidden neuron to visible neuron. In some aspects, the synaptic weights of both the forward and reverse synapses are set to the same value (wᵢⱼ).

A bias neuron may be added to each layer of neurons. Bias neurons may be used to bias the visible and hidden neurons such that the visible and hidden neurons spike with more/less probability. The bias neurons in the visible layer and the hidden layer may be respectively represented by the notation v₀ and h₀. In some aspects, a forward synapse may be provided from a bias neuron in the visible layer v₀ to each hidden layer neuron hⱼ with a weight of bⱼ. A reverse synapse may be coupled between a bias neuron in hidden layer h₀ to each visible neuron vᵢ with a weight of aᵢ. Additionally, in some aspects, forward and reverse synapses may be provided between bias neurons v₀ and h₀ with a positive weight of W_{b2b}.

The forward synapses may have a delay of d_{f} and the reverse synapses may have a delay of dᵣ. In one configuration, the delay of the forward synapses d_{f} may be equal to the delay of the reverse synapses dᵣ. In some configurations, the forward synapses and the reverse synapses may both have a unit delay (i.e., d_{f}=dᵣ=1).

### Visible/Hidden Neurons

Aspects of the present disclosure are directed to generating a binary RBM. This may be beneficial, for example because non-binary values are not encoded using binary spikes. Rather, binary RBMs represent the binary state of 1 by spiking and the binary state of 0 by not spiking.

At each time-step (tau), the hidden layer neurons (e.g., 902a, 902b, 902c) may receive synaptic current due to spike-activity of the visible neurons and bias neuron in the visible layer. Similarly, the visible neurons receive synaptic current due to the spike-activity of the hidden layer neurons and bias neuron in the hidden layer. The notation v^{(t)} and h^{(t)} may represent the visible and hidden neuron state vectors at time t.

In one configuration, the bias neurons may spike all the time. In this configuration, the overall synaptic current into the hidden neuron hⱼ at time t may be given by:

$${i}_{s} = {b}_{j} + {\sum }_{i = 1}^{n} {w}_{ij} {v}_{i}^{( t - {d}_{f} )} . \qquad ( 24 )$$

According to Equation (19), it may be desirable for the hidden neuron hⱼ to spike with a probability of sigma (iₛ). This may be accomplished, for example, by implementing an RBM using a sigmoidal activation function. That is, when the uniform distribution (Unif[0,1]) is greater than sigma (iₛ) then the hidden layer neuron may spike.

In some aspects, the RBM may be configured without any state variables (e.g., membrane potential). Instead, the hidden layer neurons may react to the input synaptic current irrespective of the past activity.

Similarly, the visible neurons may also be modeled to spike with a probability of sigma (iₛ). In other words, when the uniform distribution (Unif[0,1]) is greater than sigma (iₛ) then the visible layer neuron may spike.

Specifically, the overall synaptic current into the visible layer neuron vᵢ at time t may be given by:

$${i}_{s} = {a}_{i} + {\sum }_{i = 1}^{m} {w}_{ij} {h}_{j}^{( t - {d}_{r} )} . \qquad ( 25 )$$

The visible layer neuron vᵢ may spike with a probability of sigma (iₛ) as stated in Equation (20).

Accordingly, the visible and hidden neuron states may be updated as follows:

h⁽²⁾˜P(h|v^{(t=d)}) (26)

v⁽²⁾˜P(h|v^{(t=d)}) (27)

If, for example, forward synaptic delay d_{f} and the reverse synaptic delay dᵣ are both set to unit delay, two parallel sampling chains (e.g., Gibbs sampling chains) may be specified that are independent of each other:

v⁽⁰⁾→h⁽¹⁾→v⁽²⁾→h⁽³⁾→v⁽⁴⁾ . . .

h⁽⁰⁾→v⁽¹⁾→h⁽²⁾→v⁽³⁾→h⁽⁴⁾ . . .

In some aspects, the number of sampling chains (e.g., Gibbs sampling chains) may depend on the forward and reverse synaptic delays, and may be given by d_{f}+dᵣ which is equal to the round-trip delay:

v^{(k)}→h^{(k+d}^{_{f}}⁾→v^{(k+d}^{_{f}}^{+d}^{ᵣ}⁾→h^{(k+2d}^{_{f}}^{+d}^{ᵣ}⁾→v^{(k+2d}^{_{f}}^{+2d}^{ᵣ}⁾ . . .

where k is the index of the sampling chain that runs from 0 to d_{f}+dᵣ−1.

For example, if the forward synaptic delay is set to d_{f}=1, and the reverse synaptic delay is set to dᵣ=2, three sampling chains may be specified as:

v⁽⁰⁾→h⁽¹⁾→v⁽²⁾→h⁽⁴⁾→v⁽⁶⁾ . . .

v⁽¹⁾→h⁽²⁾→v⁽⁴⁾→h⁽⁶⁾→v⁽⁷⁾ . . .

v⁽²⁾→h⁽³⁾→v⁽⁶⁾→h⁽⁶⁾→v⁽⁸⁾ . . .

In some aspects, the sigmoid activation function described above may be approximated using an exponential function:

$$sigma ( x ) \approx \{ \begin{matrix}{2}^{a ( x - b ) - 1} , x \leq b \\ 1 - {2}^{- a ( x - b ) - 1} , x > b\end{matrix} \qquad ( 28 )$$

where and b are parameters chosen to reduce or minimize the approximation error.

In other aspects, the sigmoid activation function may be approximated using Gaussian noise. As described above, for a given iₛ, the neuron (e.g., a hidden neuron or visible neuron) may spike probabilistically with a probability of sigma (iₛ). Instead of computing the sigmoid function and generating a uniform random variable, the sigmoid function may be approximated, for example, by adding a Gaussian random variable to iₛ and comparing the sum to a threshold:

iₛ+N1(0,a)>b, (29)

where a and b are parameters chosen to reduce the approximation error.

### Bias Neurons

In one configuration, the bias neurons associated with a given population of neurons (e.g., layer of neurons) may spike whenever there is activity in that population. This can be accomplished, for example, by using a simple threshold neuron model and connecting the bias neurons in visible and hidden layers using forward and reverse synapses with positive weights. Accordingly, when a population of neurons (e.g., hidden layer neurons) picks up from another population (e.g., visible layer neurons), the corresponding bias neuron also pick up activity and spike. For instance, the bias neuron may spike if the input current (iₛ) is greater than zero. As such, if the bias neuron in the visible layer spikes at time t, the bias neuron in the hidden layer may spike at time t+d_{f}, which in turn, makes the bias neuron in the visible layer spike at time t+d_{f}+dᵣ. In another example, the activity in each population of neurons may be tracked. An external signal may be sent to the bias neurons at appropriate times based on the tracked activity to ensure that the bias neurons spike.

In some aspects, bias neuron activity may be initiated by injecting positive current for the first d_{f}+dᵣ tau. That is, the bias neurons may be set up to pick up activity for each other. However, in some aspects, the activity may be initiated or jump started (e.g., when there is no activity) by injecting external current to a bias neuron to start the bias neuron activity. The activity may be jump started separately for each parallel chain. Because there are d_{f}+dᵣ parallel chains, the number of times that jump starting may be performed may depend on the number of chains to be activated.

### Suppressing a Sampling Chain Selectively

In accordance with aspects of the present disclosure, a pre-trained RBM may be loaded to observe the states evolving through a sampling chain (e.g., parallel Gibbs sampling chains). For training and inference purposes, it may be desirable to selectively stop one or more of the sampling chains. Accordingly, in one configuration, an RBM (e.g., 900) may be modified to allow for the selectively stopping of one or more chains.

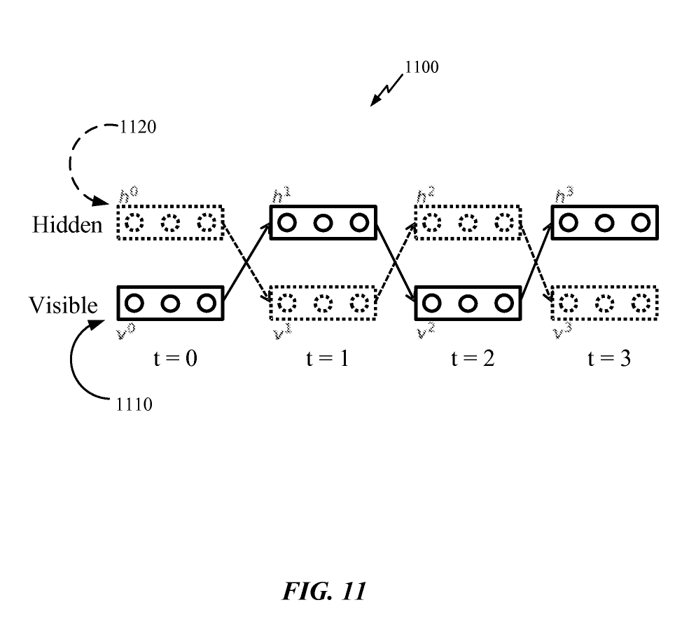

FIG. 11 is a block diagram illustrating parallel sampling chains 1100 in an RBM. In one example, consider the case of d_{f}=dᵣ=1 where two Gibbs sampling chains (1110 and 1120) active in the network are specified. The first sampling chain 1110 is v⁽⁰⁾→h⁽¹⁾→v⁽²⁾→h⁽³⁾ and the second sampling chain 1120 may be specified as h⁽⁰⁾→v⁽¹⁾→h⁽²⁾→v⁽³⁾. In some aspects, it may be desirable to stop the second sampling chain 1120 while the first sampling chain 1110 remains active.

If the hidden neuron activity (including bias neuron activity in the hidden layer) at time t=0 is stopped, the visible neurons at time t=1 (v⁽¹⁾) may not receive any input current. In one example, where sigma (0)=0.5, the visible neurons (e.g., v⁽⁰⁾) may spike with a probability of 0.5 and a new chain may be started or initiated. Therefore, along with the ability to stop an active Gibbs sampling chain, it may also be desirable to reduce the likelihood of a new chain from starting by itself.

In one exemplary configuration, the RBM neuron model may be modified so that it does not spike if input synaptic current is equal to zero. That is, the RBM may be defined such that a spike is output if the input current (iₛ) is not equal to zero and the sigma (iₛ) is less than the uniform distribution (Unif[0,1]).

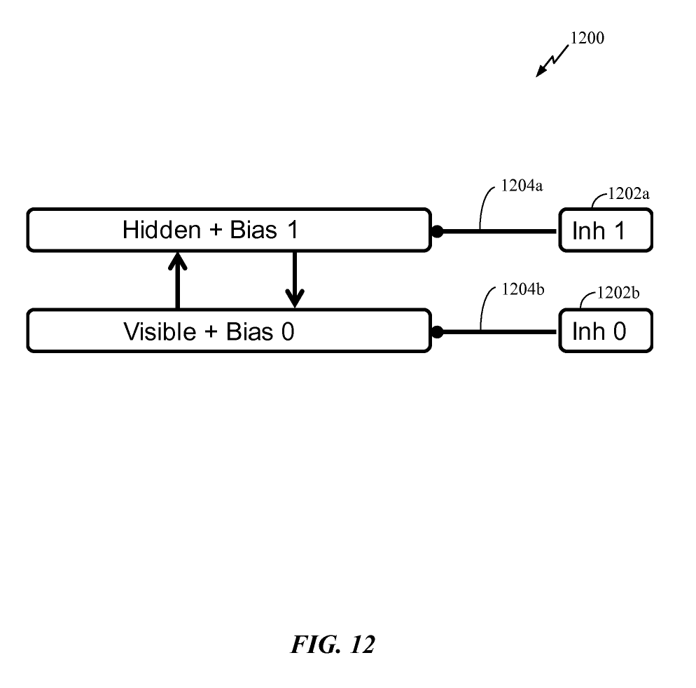

To suppress the second chain (e.g., h⁽⁰⁾→v⁽¹⁾→h⁽²⁾→v⁽³⁾→h⁽⁴⁾ . . . ) selectively, the neurons in a visible/hidden layer (e.g., h⁽⁰⁾, v⁽¹⁾) may be stopped at an appropriate time. Stopping the chain may be achieved by adding an inhibitory neuron or orchestrator neuron for each layer. That is, the orchestrator neurons interact with the visible/hidden layer neuron populations by injecting negative current to suppress the chain at an appropriate time (e.g., t=0). This is shown, by way of example, in FIG. 12. As shown in FIG. 12, orchestrator neurons 1202a and 1202b are added to the hidden layer and visible layer of an RBM 1200. With reference to the example of FIG. 11, the orchestrator neuron 1202a (Inh 1) injects negative current that arrives in the hidden layer at time t=0 to suppress the hidden layer activity h⁽⁰⁾ (shown in FIG. 11). Similarly, the orchestrator neuron 1202b (Inh 0) injects negative current that arrives in the visible layer at time t=1 to suppress the visible layer activity v⁽¹⁾ (shown in FIG. 11).

When the sampling on the second chain 1120 is stopped, the second sampling chain 1120 is in a rest state, but sampling continues to be performed on the first sampling chain 1110. In some aspects, bias neurons (e.g., Bias 0 and Bias 1) may also be added to the hidden and visible layers to modulate the spike probability.

To further aid in suppressing a sampling chain, the RBM 1200 may be configured with synapses (e.g., 1204a, 1204b) having an increased negative weight (−Wᵢₙₕ) between the inhibitory neuron and the other neurons in the layer. In some aspects, the synapses with increased negative weight may also be provided from the inhibitory neuron to the bias neurons in the layer.

In some aspects, the inhibitory weight value (Wᵢₙₕ) may be defined such that sigma (iₛ) is substantially close to zero despite possible excitatory contributions from other synapses.

### Shift Sigmoid Activation Function

In another configuration, the second chain may be suppressed by shifting the sigmoid activation function. The sigmoid activation function may be shifted using an offset current (i₀). In this configuration, the visible/hidden neurons do not spike on receiving zero synaptic current. Accordingly, the offset value iₒ may be set to a value such that the σ(−i₀) is substantially close to zero. That is, the neurons in the second chain may spike if the uniform distribution (e.g., Unif[0,1]) is greater than the shifted sigmoid activation function (sigma (iₛ−i₀)). Otherwise, the neurons in the second chain will not spike.

In some aspects, to account for this shift in an active Gibbs sampling chain, the same offset value (iₒ) may be added to the weights of synapses from bias neurons to the visible/hidden neurons. Because bias neurons may always spike in an active chain, the effect of the offset may be reduced.

As indicated above, suppression of the second sampling chain 1120 may be achieved by adding an inhibitory neuron or orchestrator neuron (e.g., 1202a, 1202b) for each layer and using synapses with strong negative weight (−Wᵢₙₕ) from the inhibitory neuron to the other neurons in that layer.

### Control Channel Approach

In yet another configuration, the second chain (e.g., 1120) may be suppressed by adding a synapse, such as an orchestrator synapse between the bias neurons and the visible and hidden neurons. In some aspects, forward synapses may be added from the bias neuron in the visible layer (v₀) to the hidden neurons, and reverse synapses may be added from the bias neuron in the hidden layer (h₀) to the visible neurons.

When the bias neurons spike, the orchestrator synapse may inject current into a control channel (different channel compared to the regular channel carrying synaptic current). As such, the RBM may be modified to spike only when it receives an input current along the control channel (i.e., i_{c}>0, and Unif[0,1]>sigma(iₛ), where i_{c} represent the overall current in the control channel.)

In some aspects, the second chain (e.g., h⁽⁰⁾→v⁽¹⁾→h⁽²⁾→v⁽³⁾→h⁽⁴⁾ . . . ) may be selectively suppressed by inhibiting the bias neuron (e.g., Bias 0 and Bias 1 in FIG. 12) in the visible/hidden layer at an appropriate time. In this configuration, the sampling chain may be terminated and may not start by itself. To start a new chain, a positive current may be input to one of the bias neurons (e.g., Bias 0 and Bias 1 in FIG. 12) at an appropriate time.

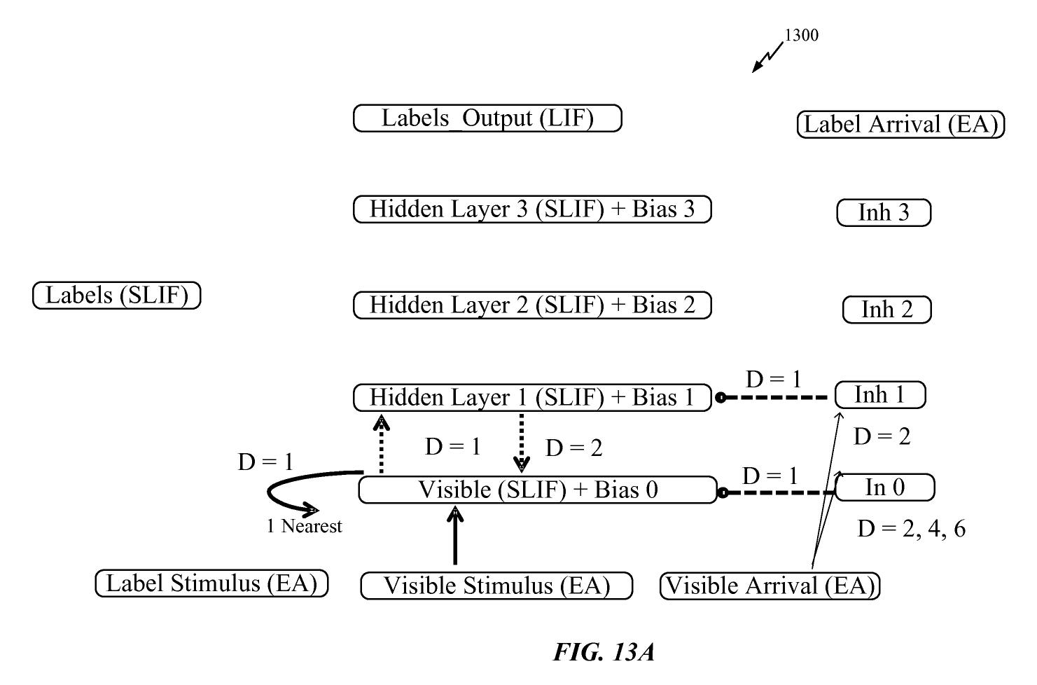

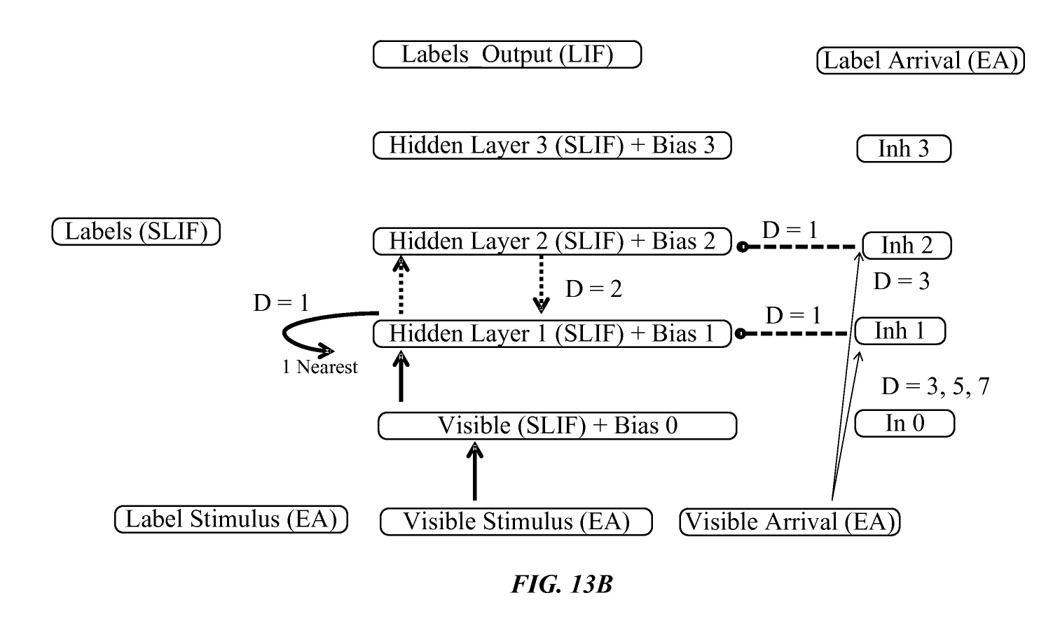

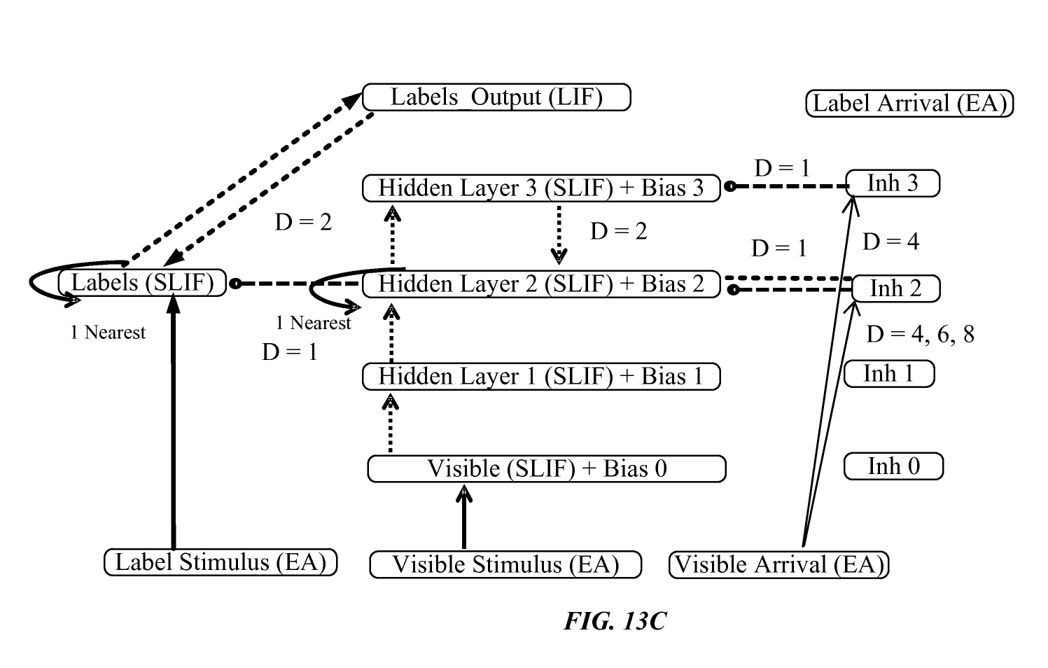

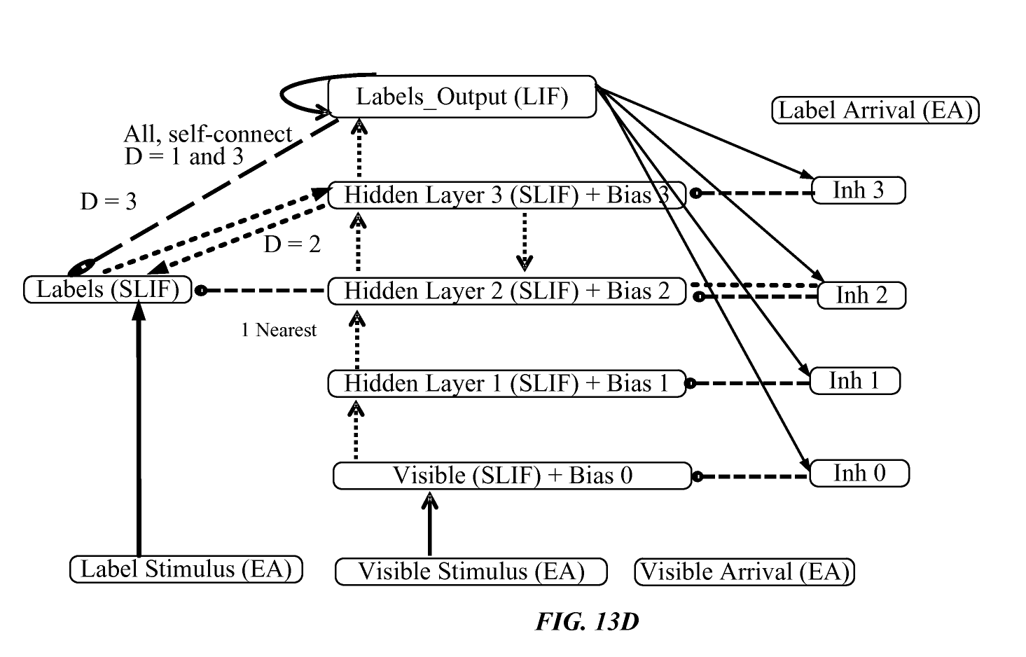

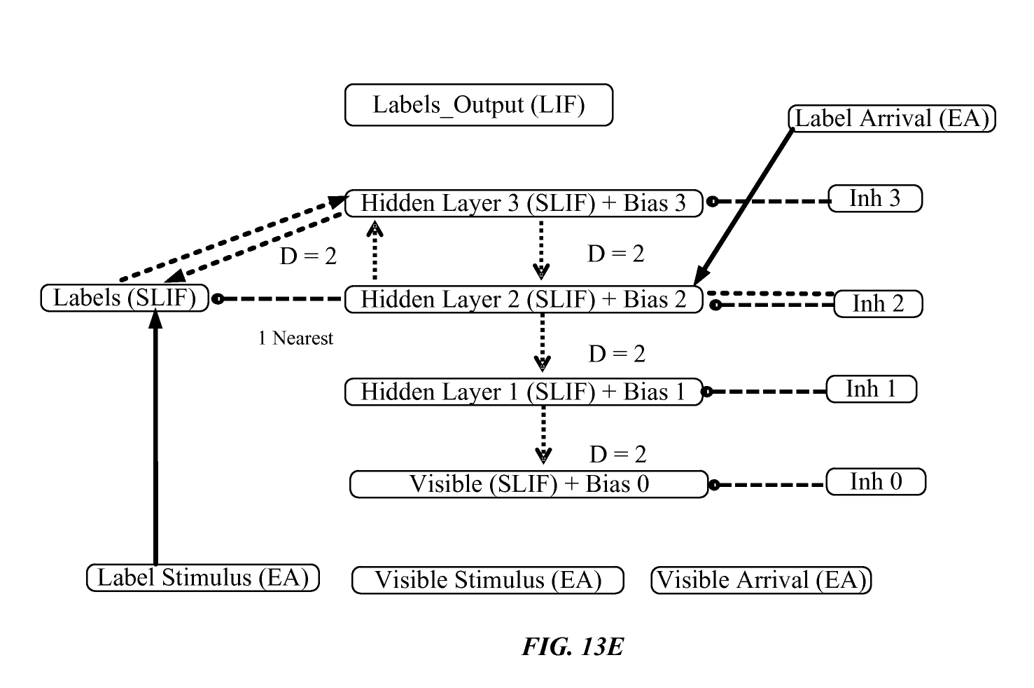

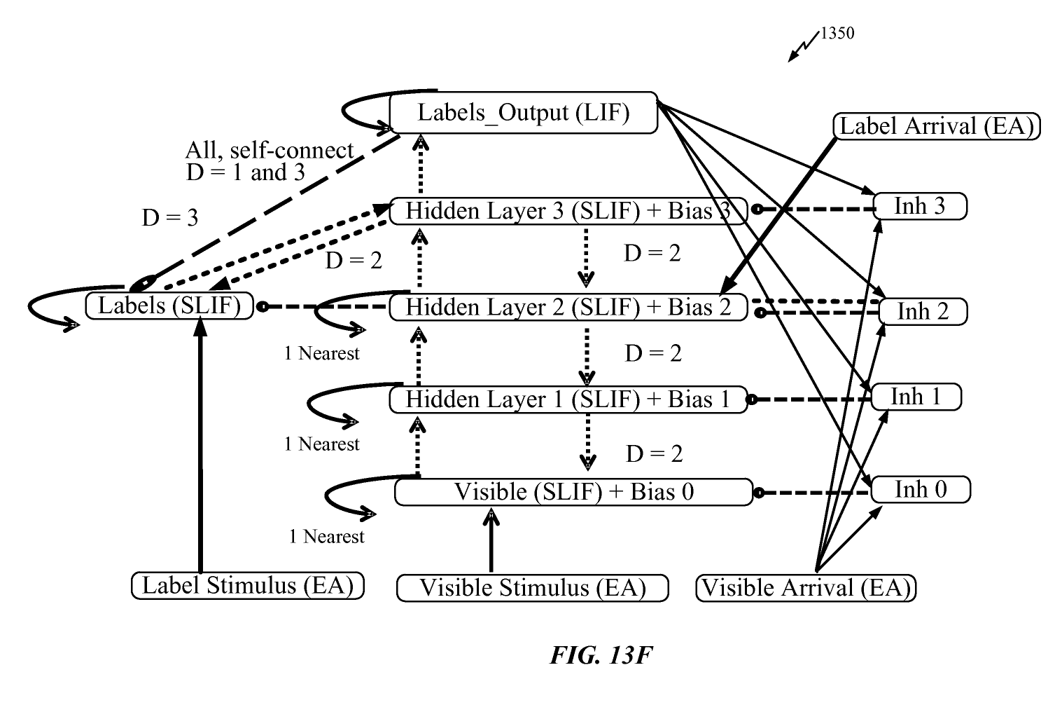

FIGS. 13A-F are block diagrams illustrating exemplary DBNs trained for classification, recognition and generation in accordance with aspects of the present disclosure. The RBMs of the exemplary DBN may be trained separately in a sequential fashion. FIG. 13A shows a DBN 1300 including a visible layer and three hidden layers. In this example, each layer of the DBN 1300 is configured with SLIF neurons. An orchestrator neuron is provided at each layer and configured to stop and/or start the sampling chain according to design preference. In FIG. 13A, a first RBM connecting the visible layer to hidden layer 1 is trained using a training technique such as CD, for example. The visible layer receives a visible stimulus (e.g., spikes) via an extrinsic axon (EA) to initiate sampling. The forward synapses are configured with a unit delay (D=1), while the reverse synapses are configured with a delay of two (D=2). Orchestrator neurons (e.g., Inh0 and Inh1) suppress sampling to subsequent layers of the DBN during training.

In FIG. 13B, a second RBM connecting hidden layer 1 to hidden layer 2 is trained. In some aspects, hidden layer 1, having been trained, may act as a visible layer for training hidden layer 2. In FIG. 13C, a third RBM connecting hidden layer 2 and labels to hidden layer may be trained. The trained DBN may in turn be used for inference as shown in FIG. 13D. An input may be sent through input stimulus axons and in turn, an output is read out from the Label_Output neurons. As shown in FIG. 13E, the DBN may be run as a generative model. In the generative model, the DBN takes the label as input through Label_Stimulus axons. The corresponding generated samples may be viewed by visualizing the spike pattern in the visible neurons. FIG. 13F illustrates an exemplary DBN 1350. As shown in FIG. 13F, an overlay of the synaptic connections in FIGS. 13A-E are included in the exemplary DBN 1350. Thus, the exemplary DBN 1350 may be configured for a particular mode of operation (e.g., handwriting classification) by switching certain connections off as shown in FIGS. 13A-E.

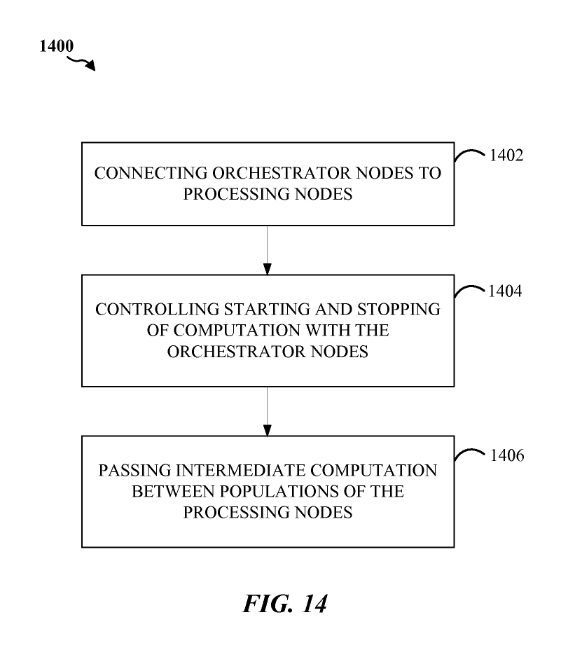

FIG. 14 illustrates a method 1400 for distributed computation. In block 1402, the neuron model connects orchestrator nodes to processing nodes. In block, 1404, the neuron model controls starting and stopping of computation with the orchestrator nodes. Furthermore, in block 1406, the neuron model passes intermediate computation between populations of processing nodes.

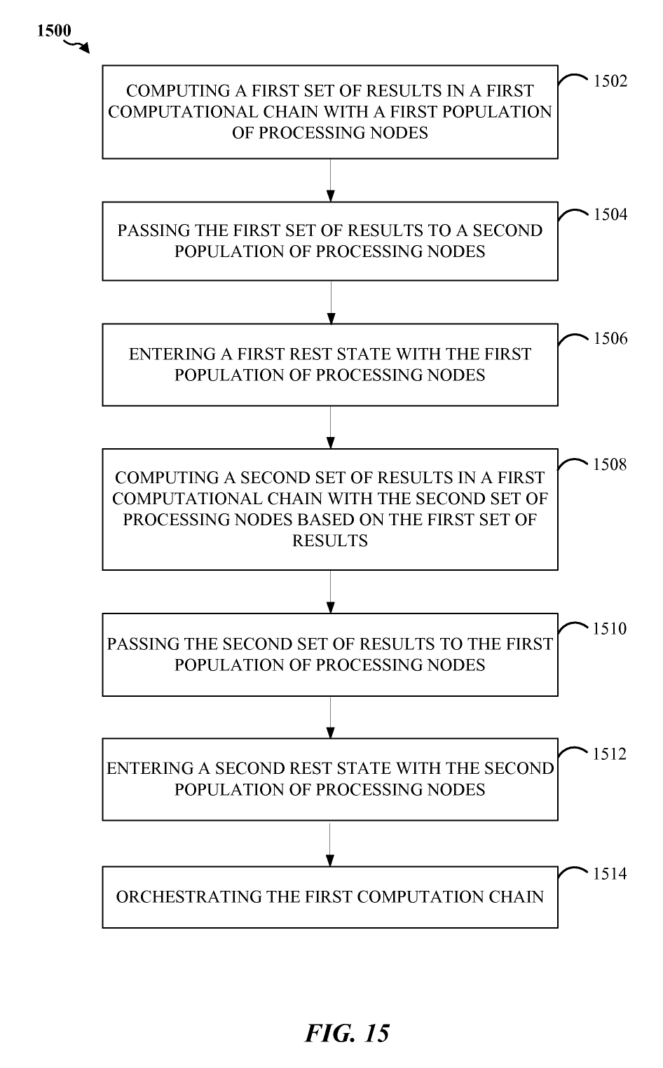

FIG. 15 illustrates a method 1500 for distributed computation. In block 1502, the neuron model computes a first set of results in a first computational chain with a first population of processing nodes. The first computational chain may comprise an SNN, a DBN, or a Deep Boltzmann Machine, for example. The first computational chain (e.g., a DBN) may be trained via STDP, or other learning techniques.

In block, 1504, the neuron model passes the first set of results to a second population of processing nodes. In block 1506, the neuron model enters a first rest state with the first population of processing nodes after passing the first set of results. In some aspects, the first rest state may include synaptic delays and increased synaptic delays that are used for operating multiple persistent chains in parallel and weight updates that are averaged over the parallel chains.

In block 1508, the neuron model computes a second set of results in a first computational chain with the second set of processing nodes based on the first set of results. In block 1510, the neuron model passes the second set of results to the first population of processing nodes. In block 1512, the neuron model enters a second rest state with the second population of processing nodes after passing the second set of results.

In block 1514, the neuron model orchestrates the first computational chain. The orchestrating may be conducted via an external input, which may be excitatory or inhibitory. The orchestrating may also be conducted by passing in-band message tokens.

In some aspects, the processing nodes may comprise neurons. The neurons may be LIF neurons, SLIF neurons, or other types of model neurons.

In some aspects, orchestrating the first computational chain may include controlling the timing of passing results between populations of processing nodes. In other aspects, the orchestrating includes controlling the timing of the rest states. In further aspects, orchestrating includes controlling the timing of computing a set of results.

In some aspects, the method may further include performing additional computations by the first population of processing nodes during the first rest state, creating parallel computational chains. The parallel computational chains may comprise a persistent chain and a data chain. The hidden and visible neurons may have an alternating arrangement between the persistent chain and the data chain to learn using persistent contrastive-divergence (CD) or other learning techniques.

In some aspects, the method may further include resetting the first computational chain with orchestration via an in-band message token passing or external input.

In some aspects, at least one internal node state or node spike may trigger starting and/or stopping of a round of computation.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering. Although the present disclosure is described with respect to spiking neural networks, the present disclosure equally applies to any distributed implementation having autonomous neurons.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of distributed computation, comprising:
computing a first set of results in a first computational chain with a first population of processing nodes;
passing the first set of results to a second population of processing nodes;
entering a first rest state with the first population of processing nodes after passing the first set of results;
computing a second set of results in the first computational chain with the second population of processing nodes based at least in part on the first set of results;
passing the second set of results to the first population of processing nodes;
entering a second rest state with the second population of processing nodes after passing the second set of results; and
orchestrating the first computational chain.

2. The method of claim 1, further comprising performing additional computations by the first population of processing nodes during the first rest state, creating parallel computational chains.

3. The method of claim 2, in which the parallel computational chains comprise a persistent chain and a data chain with hidden and visible neurons alternating between the persistent chain and the data chain to learn using persistent contrastive-divergence (CD).

4. The method of claim 1, in which the first rest state comprises synaptic delays and increased synaptic delays are used for operating multiple persistent chains in parallel and weight updates are averaged over the parallel chains.

5. The method of claim 1, in which the orchestrating comprises controlling a timing of passing the first and second sets of results, the first rest state, the second rest state, computing the first set of results or computing the second set of results.

6. The method of claim 1, in which the orchestrating is conducted via an external input.

7. The method of claim 6, in which the external input is excitatory.

8. The method of claim 6, in which the external input is inhibitory.

9. The method of claim 1, in which the orchestrating is conducted via in-band message token passing.

10. The method of claim 1, further comprising resetting the first computational chain with orchestration via in-band message token passing or external input.

11. The method of claim 1, in which the first population of processing nodes and the second population of processing nodes comprise neurons.

12. The method of claim 1, in which the first computational chain comprises a spiking neural network.

13. The method of claim 1, in which the first computational chain comprises a Deep Belief Network (DBN).

14. The method of claim 13, in which layers of the DBN are trained using spike timing-dependent plasticity (STDP).

15. The method of claim 1, in which the first computational chain comprises a Deep Boltzmann Machine.

16. The method of claim 1, in which at least one internal node state or node spike triggers a starting or stopping of a round of computation.

17. An apparatus for distributed computation, comprising:
a memory; and
at least one processor coupled to the memory, the at least one processor configured:
to compute a first set of results in a first computational chain with a first population of processing nodes;
to pass the first set of results to a second population of processing nodes;
to enter a first rest state with the first population of processing nodes after passing the first set of results;
to compute a second set of results in the first computational chain with the second population of processing nodes based at least in part on the first set of results;
to pass the second set of results to the first population of processing nodes;
to enter a second rest state with the second population of processing nodes after passing the second set of results; and
to orchestrate the first computational chain.

18. The apparatus of claim 17, in which the at least one processor is further configured to perform additional computations by the first population of processing nodes during the first rest state, creating parallel computational chains.

19. The apparatus of claim 18, in which the parallel computational chains comprise a persistent chain and a data chain with hidden and visible neurons alternating between the persistent chain and the data chain to learn using persistent contrastive-divergence (CD).

20. The apparatus of claim 17, in which the first rest state comprises synaptic delays and increased synaptic delays are used for operating multiple persistent chains in parallel and weight updates are averaged over the parallel chains.

21. The apparatus of claim 17, in which the at least one processor is further configured to orchestrate the first computational chain by controlling a timing of passing the first set of results and the second set of results, the first rest state, the second rest state, computing the first set of results or computing the second set of results.

22. The apparatus of claim 17, in which the at least one processor is further configured to orchestrate the first computational chain via an external input.

23. The apparatus of claim 22, in which the external input is excitatory.

24. The apparatus of claim 22, in which the external input is inhibitory.

25. The apparatus of claim 17, in which the at least one processor is further configured to orchestrate the first computational chain via in-band message token passing.

26. The apparatus of claim 17, in which the at least one processor is further configured to reset the first computational chain with orchestration via in-band message token passing or external input.

27. The apparatus of claim 17, in which the first population of processing nodes and the second population of processing nodes comprise neurons.

28. The apparatus of claim 17, in which the first computational chain comprises a spiking neural network.

29. The apparatus of claim 17, in which the first computational chain comprises a Deep Belief Network (DBN).

30. The apparatus of claim 29, in which layers of the DBN are trained using spike timing-dependent plasticity (STDP).

31. The apparatus of claim 17, in which the first computational chain comprises a Deep Boltzmann Machine.

32. The apparatus of claim 17, in which the at least one processor is further configured to trigger a starting or stopping of a round of computation based at in part on at least one internal node state or node spike.

33. An apparatus for distributed computation, comprising:
means for computing a first set of results in a first computational chain with a first population of processing nodes;
means for passing the first set of results to a second population of processing nodes;
means for entering a first rest state with the first population of processing nodes after passing the first set of results;
means for computing a second set of results in the first computational chain with the second population of processing nodes based at least in part on the first set of results;
means for passing the second set of results to the first population of processing nodes;
means for entering a second rest state with the second population of processing nodes after passing the second set of results; and
means for orchestrating the first computational chain.

34. A computer program product for distributed computation, comprising:
a non-transitory computer readable medium having encoded thereon program code, the program code comprising:
program code to compute a first set of results in a first computational chain with a first population of processing nodes;
program code to pass the first set of results to a second population of processing nodes;
program code to enter a first rest state with the first population of processing nodes after passing the first set of results;
program code to compute a second set of results in the first computational chain with the second population of processing nodes based at least in part on the first set of results;
program code to pass the second set of results to the first population of processing nodes;
program code to enter a second rest state with the second population of processing nodes after passing the second set of results; and
program code to orchestrate the first computational chain.
